(19) United States
(12) Patent Application Publication
(10) Pub. No.: US 2014/0290156 A1
(43) Pub. Date: Oct. 2, 2014

(54) NARROW PROFILE MULTI-PANE WINDOW ASSEMBLY

(71) Applicants: Kevin Bruce, Warroad, MN (US); Dale A. Dreyer, Bemidji, MN (US)

(72) Inventors: Kevin Bruce, Warroad, MN (US); Dale A. Dreyer, Bemidji, MN (US)

(21) Appl. No.: 14/228,012

(22) Filed: Mar. 27, 2014

Related U.S. Application Data
(60) Provisional application No. 61/806,150, filed on Mar. 28, 2013.

(51) Int. Cl. E06B 3/677; E06B 3/66

(52) U.S. Cl. CPC E06B 3/677; E06B 3/66
USPC 52/171.3; 52/204.593

(57) ABSTRACT

An insulated glass unit includes a first outer glass pane having a first thickness and a second outer glass pane having a second thickness. One or more inner glass panes can include one or more glass ribbons that are interposed between the outer glass panes. At least one of the inner glass panes can have a thickness that is less than the first and second thicknesses. An edge assembly is coupled between the outer glass panes. The edge assembly can be configured to receive an edge portion of the one or more inner glass panes, such as to retain the one or more inner glass panes at respective positions that are spaced apart from, and generally parallel to, the first and second outer glass panes. In an example, side edges of the one or more inner glass panes are recessed from corresponding side edges of the outer glass panes.

### CLAIM OF PRIORITY

This application claims the benefit of priority under 35 U.S.C. §119(e) of U.S. Provisional Patent Application Ser. No. 61/806,150, entitled “NARROW PROFILE MULTI-PANE WINDOW ASSEMBLY”, filed on Mar. 28, 2013, which is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Marvin Cedar Company (d/b/a Marvin Windows and Doors), Warroad, Minn. All Rights Reserved.

### TECHNICAL FIELD

This document pertains generally, but not by way of limitation, to multi-pane window assemblies.

### BACKGROUND

An insulating glass unit (IGU) generally comprises at least two glass panes, or glazings, that are mounted in a common frame and spaced apart from each other to provide an enclosed airspace between the panes. One or more spacers can be provided to maintain the separation of the glass panes. The one or more spacers can also include a gas-impermeable portion to seal the enclosed airspace between the panes. The airspace can be filled with an insulating gas or evacuated to reduce heat transfer across the airspace and therefore across the insulating glass unit.

One strategy to improve performance of an insulated glass unit is to provide multiple airspaces. Some IGUs use three or more conventional glass panes to provide multiple airspaces, including multiple respective spacers positioned between the panes. Such multi-pane IGU configurations are heavier, thicker, and transmit proportionally less light than their double-pane IGU counterparts.

In one example, an insulating unit includes a transparent film in place of a central glass pane. The film can be secured to a frame or other rigid, non-deformable spacer about a perimeter of the insulating unit. In some examples, a film is coupled to a metal portion of a rigid spacer. An inner film can be tensioned using one or more of mechanical or thermal processes to attempt to remove non-uniformities in the film.

Although using a film can reduce an overall weight of an insulating unit, there are several drawbacks and manufacturing challenges to using a film as an inner member of an insulating window unit. For example, some films can become discolored over long periods of exposure to light. Some films are prone to wrinkling at corners or edges. Some films may lose tension over long periods and begin to show wrinkles or other deformations. In some examples, film wrinkling and other film-related inconsistencies can be more prevalent in non-rectangular units. For example, wrinkling can be prevalent in window units having one or more corners at acute angles, or in window units having more than 4 corners, such that at least some of the corners are at obtuse angles. Furthermore, film is not used in large aspect ratio rectangular window units, such as having an aspect ratio greater than about 8:1 (long side relative to short side).

### OVERVIEW

The present inventors have recognized, among other things, that a problem to be solved can include providing a narrow-profile, light-weight, multiple-pane window assembly, such as without using a film-based central member. The present disclosure can provide a solution to this problem, such as by providing systems and methods for using a glass ribbon as a central pane in a tri-pane insulating glass unit. In an example, the glass ribbon can be held between a pair of spacers on opposite sides of the glass ribbon using a viscous, gas-impermeable, flowable seal. That is, in contrast to a film that is rigidly held in place at its perimeter edge using a rigid spacer, the inner glass pane comprising a glass ribbon can be positioned between spacers, for example using a unitary seal on each side of the glass ribbon, such as without a mechanical fastener or other adhesive to secure the glass ribbon to one or more of the spacers. In an example, the spacers can be flexible, non-metallic spacers, or the spacers can be thin-wall, metallic, warm-edge spacers. A secondary seal can optionally be provided, such as at an outer edge of the insulating glass unit, such as to provide structural integrity, and to optionally receive one or more edge portions of the glass ribbon. In an example, the glass ribbon can have a nominal thickness that is about 0.2 mm or less.

The present inventors have further recognized that a problem to be solved can include modifying existing multi-pane window structures to accommodate an inner glass pane formed from a glass ribbon. The present disclosure can provide a solution to this problem, such as by modifying only spacer or seal widths in existing units, for example, including units having glazing pockets that are about 0.75 inches wide. In an example, an inner glass pane formed from a glass ribbon is held in a central, interposing position in the insulating glass unit using only unitary, gas-impermeable seals at its edges. That is, the inner glass pane can be positioned and held in place without using an adhesive or other mechanical means to affix the pane to one or more spacers or to other portions of the unit assembly. Optionally, one or more edges of the inner glass pane can be positioned away from an outer edge of the unit assembly, such as recessed from an outer edge of one or more of the outer glass panes. The one or more edges of the inner glass pane that are positioned away from the outer edge can be received, for example in a secondary seal, to protect the edges of the inner glass pane.

An example of an insulating glass unit can include a pair of outer glass panes that are spaced apart. Each of the outer glass panes can have substantially the same perimeter length and planar profile. At least one flexible, inner glass pane can be positioned between the pair of outer glass panes, and the inner glass pane can be spaced apart from each of the outer glass panes to provide first and second gas chambers on opposite sides of the inner glass pane. The inner glass pane can have a perimeter length that is less than the perimeter length of one or both of the outer glass panes, however, the inner glass pane can have a substantially similar profile shape as each of the outer glass panes. The inner glass pane can include two or more side edges that are recessed relative to corresponding edges of the outer glass panes, can be an uncoiled glass ribbon, and can have a nominal thickness that is less than a nominal thickness of either one of the outer glass panes by an order of magnitude or more. The first and second gas chambers can be in fluid communication using a fluid path or port, such as a cutaway (e.g., formed using a laser to cut the inner glass pane) at a corner of the inner glass pane.

Optionally, one or more inner glass panes formed from glass ribbon stock can have a projection portion that protrudes or extends outward, such as beyond spacers included at a perimeter edge portion of an insulating glass unit. A secondary seal, such as comprising silicone, polyurethane, or other material, can encapsulate the projection to protect the edge of the inner glass pane from damage, such as damage that could result in a crack propagating through a portion of the inner glass pane. The secondary seal can bond to the projection to affix the inner glass pane in the insulating glass unit assembly. In one example, the projection extends about 1.5 mm beyond an outer perimeter of the spacers and into the secondary seal.

Engaging or affixing a seal to the one or more inner panes at their respective edges, such as using respective projection portions of the inner panes, can protect the edges of the inner glass panes from damage, and can stabilize the one or more inner glass panes in the insulating glass unit. Stated another way, the one or more inner panes are “protected” by the seal and the outer panes of glass because outer edges of the one or more inner panes are recessed relative to the corresponding outer edges of each of the outer glass panes. The outer glass panes are generally thicker than the inner panes, and can be more structurally robust.

In an example, one or more dividing bars can be provided within the one or more airspaces between the inner glass pane and the outer glass panes for aesthetic purposes.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective section view of an example of a tri-pane insulating glass unit.

FIG. 2 is a cross-sectional side view of a portion of a tri-pane insulating glass unit.

FIG. 3 is a cross-sectional side view of a portion of an insulating glass unit that includes a fluid communication port.

FIG. 4A is a perspective view of an example of an insulating glass unit assembly that includes a fluid communication path formed in a glass ribbon.

FIG. 4B is a top view of an inner glass pane with a cutaway corner section.

FIG. 5 is a cross-sectional side view of a portion of a quad-pane insulating glass unit.

FIG. 6A illustrates generally a glass ribbon roll.

FIG. 6B illustrates generally an example of a system for forming a flexible glass ribbon.

FIG. 7 illustrates generally an example that can include preparing an insulating glass unit using a glass ribbon.

### DETAILED DESCRIPTION

An insulating glass unit (IGU) can use one or more thin glass panes interposed between and spaced apart from outer, thicker glass panes, to provide insulation and to inhibit heat transfer across the unit. Incorporating one or more thin panes of glass as inner, interposing panes in tri-pane and quad-pane IGUs addresses a need for an aesthetically-pleasing, lightweight, and relatively thin IGU with superior durability, including ultraviolet stability over time. In addition, by reducing an overall profile of an IGU using a thin inner glass pane, other material requirements for construction of the unit (or of a window assembly that includes the unit) can be reduced, such as including frame, sash, or hardware material requirements. Such material reduction can in turn lead to cost savings.

In an example, a narrow-profile glass stock can be used for one or more inner panes of an IGU. A narrow-profile or thin glass pane can be formed from, among other products, a glass ribbon, such as Willow Glass® by Corning. The narrow-profile or thin glass pane can be an ultra-thin, flexible glass sheet or ribbon having a nominal thickness of about 0.2 mm or less, although thicker or thinner glass sock can be used. Glass ribbon can provide several advantages over other, non-glass materials, such as PET or other films. A glass ribbon does not require tensioning, and will not wrinkle, fade, or discolor over time. In addition, a glass ribbon can be cut or formed in any shape, such as including non-rectangular shapes like triangles, circles, or any shapes that include arcs, acute angles, or obtuse angles. A glass ribbon can have a high or low length-to-width aspect ratio.

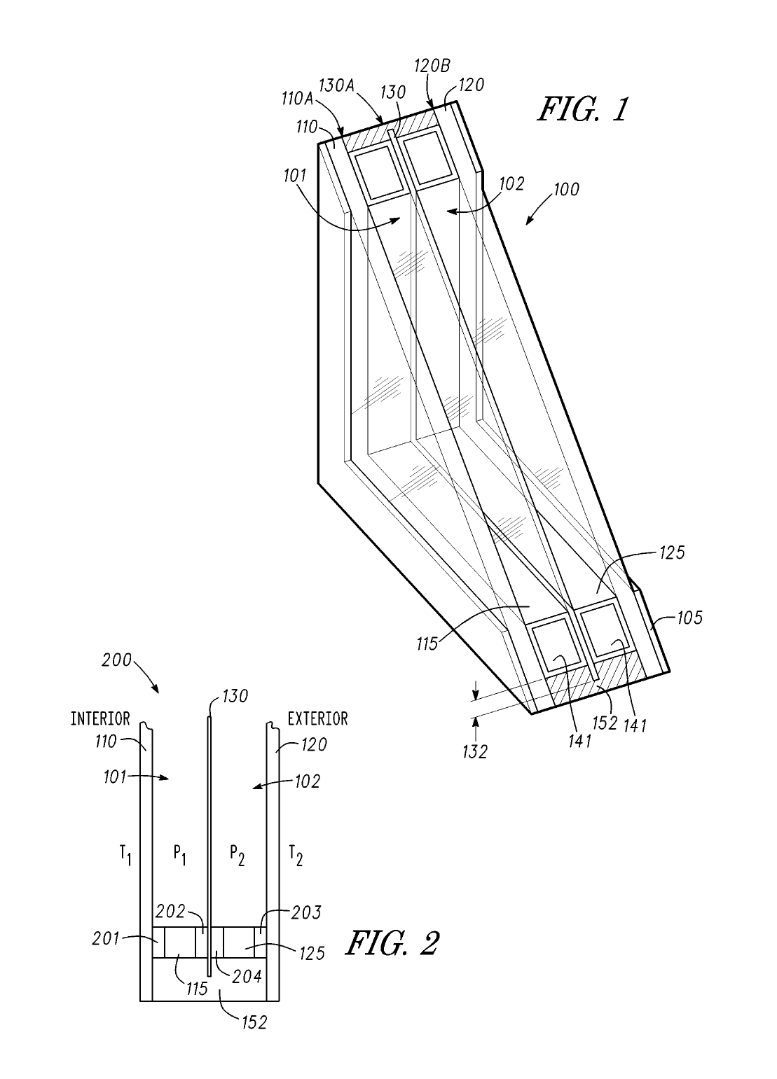

FIG. 1 is a perspective view of an example of a tri-pane insulating glass unit (IGU) 100. The IGU 100 includes a first outer glass pane 110 and a second outer glass pane 120 mounted in a frame 105. The IGU 100 further includes an inner glass pane 130. The inner glass pane 130 is spaced apart from the first outer glass pane 110 by a first spacer 115, and spaced apart from the second outer glass pane 120 by a second spacer 125 to provide respective first and second airspaces 101 and 102 between the panes. In the example of FIG. 1, the first and second spacers 115 and 125 maintain the first and second outer glass panes 110 and 120 in a spaced apart and substantially parallel configuration. Non-parallel configurations can also be used. In an example, one or more of the first and second outer glass panes 110 and 120 and the inner glass pane 130 can be transparent to visible light, and can optionally include one or more coatings such that the panes are reflective of infrared light or tinted to filter a portion of the visible light spectrum.

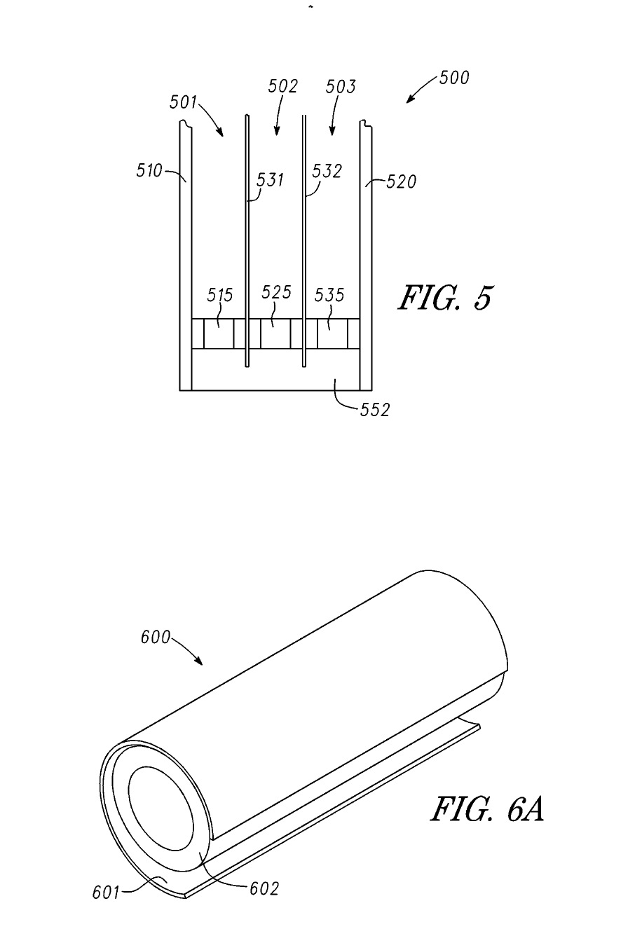

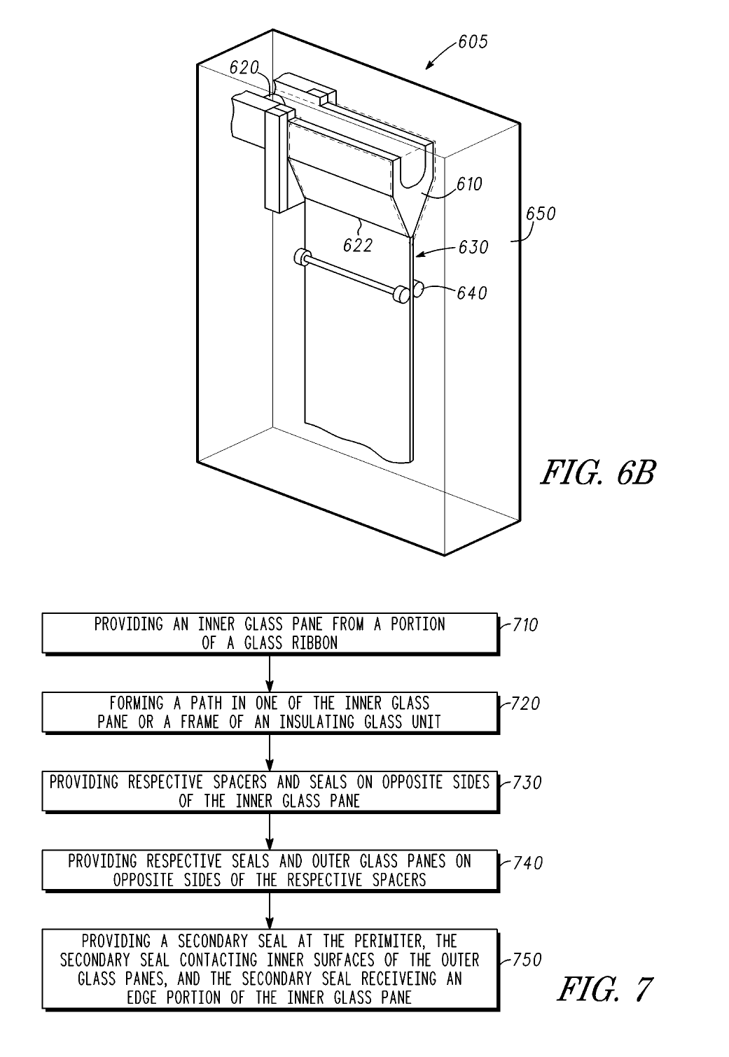

The inner glass pane 130 can include a ribbon glass pane that has a thickness that is less than a thickness of either of the first and second outer glass panes 110 and 120. In an example, the first and second outer glass panes 110 and 120 can have different thickness characteristics. Ribbon glass, such as comprising the inner glass pane 130, is further discussed herein in detail, for example, at FIGS. 6A and 6B. In some examples, one or more of the outer glass panes can include a thin glass ribbon.

In the example of FIG. 1, the inner glass pane 130 is interposed or sandwiched between the first and second spacers 115 and 125. Primary seals (not shown in FIG. 1; see, e.g., FIG. 2) can be used to provide gas-impermeable barriers at junction areas between the inner glass pane 130 and inner pane-facing surfaces of the first and second spacers 115 and 125, such as to provide air-tight first and second airspaces 101 and 102. For example, to provide a seal about an edge of the first airspace 101, a primary seal, such as including polyisobutylene or other gas-impermeable material, can be applied at a junction between a first surface 130A of the inner glass pane 130 and an adjacent surface of the first spacer 115. The primary seal can optionally further include polyisobutylene or other material at a junction between an interior surface 110A of the first outer glass pane 110 and an adjacent surface of the first spacer 115. In this manner, the first airspace 101 can be an air-tight gas chamber bounded by the first outer glass pane 110, the first spacer 115, the inner glass pane 130, and one or more gas-impermeable seals provided about or in the junctions between opposite surfaces of the first spacer 115 and the glass panes. This arrangement can be similarly provided for the second airspace 102. Although polyisobutylene is discussed herein as a preferred gas-impermeable sealant, other gas-impermeable sealants can be used. One or both of the first and second airspaces 101 and 102 can be evacuated or filled with a gas, such as an insulating gas. For example, argon can be used in one or both airspaces.

The first and second spacers 115 and 125 can include similar or dissimilar materials. In some examples, the first and second spacers 115 and 125 include permeable surfaces that face the interior first and second airspaces 101 and 102, and gas-impermeable surfaces that face the exterior of the unit. One or both of the spacers can be rigid (e.g., metallic, including aluminum or stainless steel, high-durometer rubber, rigid polymers, or other materials that are relatively stiff) or deformable (e.g., silicone, PVC, or other materials that can be relatively soft). In an example, one or both of the first and second spacers 115 and 125 can include a hollow interior portion, such as can be filled with a desiccant 141. In an example, a desiccant can be included as a portion of a matrix of a spacer unit itself, such as provided in Quanex's Super Spacer®. The first and second spacers 115 and 125 can have similar or dissimilar cross section profiles, and can be differently sized. In some examples, each of the first and second spacers 115 and 125 includes at least first and second spacer surfaces that are substantially flat and parallel to each other such that adjacent surfaces of the glass panes in the IGU 100 are parallel.

In the example of FIG. 1, the IGU 100 includes a secondary seal 152 that can extend around all or a portion of the perimeter of the unit. In an example, the secondary seal 152 includes multiple discrete portions, such as joined at the corners of the IGU 100. The secondary seal 152 can include a rigid or semi-rigid material, such as polyurethane or silicone, although other materials can be used as well. The secondary seal 152 can optionally be gas-impermeable, can provide the IGU 100 with structural integrity and rigidity at the outer edge of the unit, and can protect edges of one or more of the glass panes in the IGU 100.

The secondary seal 152 can be used to fill a space outside of an outer perimeter of the first and second spacers 115 and 125 and between the interior surface 110A of the first outer glass pane 110 and an interior surface 120B of the second outer glass pane 120. The secondary seal 152 can thus support the primary seal, such as to prevent the primary seal from creeping away from its intended locations between the spacer surfaces and the adjacent glass panes. In an example, at least a portion of a side edge of the inner glass pane 130 can be disposed in or against the secondary seal 152. For example, the inner glass pane 130 can include a projection portion 132 that extends away from an exterior surface of one or both of the first and second spacers 115 and 125. Stated differently, the projection portion 132 of the inner glass pane extends past an outer surface of at least one of the first and second spacers 115 and 125, and the projection portion 132 is received in the secondary seal 152. In an example, the projection portion 132 extends into the secondary seal 152, and an outer edge of the projection portion 132 is recessed from an outer edge or perimeter of the IGU 100. For example, the projection portion 132 can have a length of about 1.5 mm, and an outer surface of at least one of the first and second spacers 115 and 125 can be recessed from an outer edge of the IGU 100, such as by at least about 2 mm. In this manner, the projection portion 132 or outer perimeter edge of the inner glass pane can be affixed and protected within the edge assembly of the IGU 100.

In some examples, one or both of the primary and secondary seal 152 is deformable or deflectable such that one or both of the seals protect the inner glass pane 130. By providing some ability to absorb or permit movement of the inner glass pane 130 relative to the first and second outer glass panes 110 and 120, breakage of the inner glass pane 130 can be avoided, such as during manufacturing, when the unit is rapidly raised or lowered in a window assembly, or during shipping. In some examples, the primary and secondary seal 152 secure the inner glass pane 130 in place and inhibit movement of the inner glass pane 130 relative to the first and second outer glass panes 110 and 120.

In an example, the secondary seal 152, such as alone or together with one or more of the first and second spacers 115 and 125 and the primary seal, can maintain the inner glass pane 130 in a desired position within the IGU 100. The various seals and spacers can constrain movement of the inner glass pane 130 to prevent the inner glass pane 130 from warping or moving over time.

FIG. 2 illustrates generally a cross-sectional side view 200 of a portion of the IGU 100. In the example of FIG. 2, the IGU 100 includes, at an edge portion of the first airspace 101, first and second primary seals 201 and 202. The IGU 100 further includes, at an edge portion of the second airspace 102, third and fourth primary seals 203 and 204. In addition to the discussion above regarding primary seals, a primary seal can include any gas-impermeable material, such as polyisobutylene, or any other material that can provide a stable, gas-impermeable seal (e.g., stable over time and stable over fluctuations in temperature or pressure) between a surface of a substantially planar glass pane and an adjacent surface, such as an adjacent spacer surface.

A primary sealant material can be flowed, stamped, or otherwise manually or automatically applied to a target surface, such as a glass pane surface or a spacer surface. In an example, a bead of primary sealant material can be flowed manually or automatically from a dispenser along a length of a spacer surface. In an example, the spacer surface is a continuous surface, such as having a rectangular, circular, or other closed shape. Once the primary sealant material is flowed to provide a continuous bead over the spacer surface, a glass pane can be provided against the continuous bead such that the continuous bead is between the glass pane surface and the spacer surface. Pressure can optionally be applied to one or both of the spacer and the glass pane, such as to remove any bubbles or other inconsistencies in the primary seal.

In the example of FIG. 2, the first primary seal 201 is positioned or provided between the first spacer 115 and the first outer glass pane 110. The second primary seal 202 is positioned or provided between the first spacer 115 and the inner glass pane 130. Similarly, the third and fourth primary seals 203 and 204 can be positioned or provided between the second spacer 125 and respective adjacent surfaces of the inner glass pane 130 and the second outer glass pane 120. In an example, one or more of the first, second, third, or fourth primary seals 201, 202, 203, or 204, includes a sealant material that is different than the other primary seals. For example, the second and fourth primary seals 202 and 204 can include a first sealant material that contacts a surface of the inner glass pane 130, and the first and third primary seals 201 and 203 can include a second, different sealant material that contacts a surface of the first and second outer glass panes 110 and 120, respectively.

FIG. 2 illustrates generally that an interior side of the IGU 100, such as at an outside surface of the first outer glass pane 110, can be at a first temperature T₁. An exterior side of the IGU 100, at an outside surface of the second outer glass pane 120, can be at a second temperature T₂. Under such conditions, a thermal gradient exists across the IGU 100. Each of the first and second airspaces 101 and 102 can be at different temperatures and correspondingly at different pressures P₁ and P₂, such as when the same gas type occupies each of the airspaces. As the temperature difference between T₁ and T₂ increases, the pressure difference between P₁ and P₂ can correspondingly increase. Under some circumstances, a sufficient difference between P₁ and P₂ can result in bowing or flexing of the inner glass pane 130, which can lead to distortion of light transmitted through the inner glass pane 130, or breakage of the inner glass pane 130. A gas exchange can optionally be provided between the first and second airspaces 101 and 102 to enable fluid communication between the airspaces and to equalize or minimize pressure differences, while minimizing thermal transfer across the IGU 100. Various techniques can be used to provide gas exchange between the airspaces.

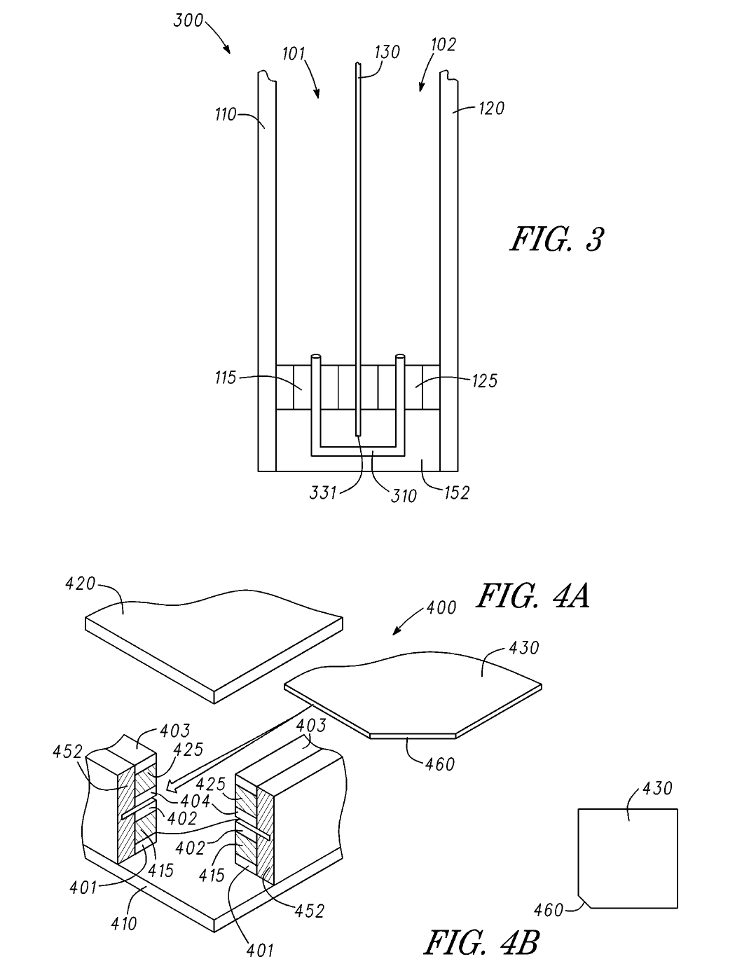

FIG. 3 illustrates generally a cross-sectional side view 300 of a portion of the IGU 100 that includes a first fluid path 310. The first path 310 includes a conduit that is open to and extends between each of the first and second airspaces 101 and 102. In an example, the first path 310 includes a tube (e.g., having a circular or non-circular cross section) having a substantially hollow core. Although the example of

FIG. 3 illustrates a single port, multiple ports can be provided at different positions about a perimeter of the IGU 100. In an example, a cross-sectional area of the conduit of the first path 310 can be about 1 square mm. Larger or smaller conduits can be used as well. The size of the conduit can be selected based on, among other factors, a desired amount or rate of fluid exchange, and a number of ports to be included in the full unit assembly.

In some examples, a tube comprising a portion of the first path 310 is at least partially filled with one or more materials configured to regulate airflow or to prevent liquid transmission through the first path 310. In an example, at least one end of the first path 310 includes a flexible membrane or diaphragm that can flex in response to a pressure change. The flexible membrane or diaphragm can have a stiffness characteristic that is less than a stiffness of the characteristic of the flexible inner glass pane.

In the example of FIG. 3, the first path 310 extends from the first airspace 101, through the first spacer 115, and into the secondary seal 152. The first path further extends around an outer edge 331 of the inner glass pane 130. The first path 310 then passes through the second spacer 125 and into the second airspace 102. In an example, a spacing member or a portion of the secondary seal 152 is provided between the outer edge 331 of the inner glass pane 130 and the conduit of the first path 310, such as to prevent the outer edge 331 from contacting the first path 310.

Other paths can be used to provide fluid (gas) communication between the first and second airspaces 101 and 102. For example, a path can optionally extend from the first airspace 101, through the first outer glass pane 110, and through a portion of a frame of the IGU 100. A similar path can be provided from the second airspace 102, through the second outer glass pane 110, and through a different portion of the frame of the IGU 100. In an example, ports that extend through respective portions of the frame of the IGU 100 can be open to their respective sides of the IGU 100, or the ends of the respective ports can be terminated using a flexible membrane or diaphragm, for example, to retain a thermally-insulating gas in one or both of the airspaces. In other examples, the ports extending through respective portions of the frame of the IGU 100 can be coupled to provide fluid communication or exchange between the first and second airspaces 101 and 102 via a passage that extends through a portion of the frame of the IGU 100.

FIG. 4A illustrates generally a perspective view of an example of an IGU assembly 400 that includes a second path that provides fluid communication between opposite sides of an inner glass pane 430. The second path can include a cutaway section 460 of the inner glass pane 430 such that fluid communication is provided between airspaces on opposite sides of the inner glass pane 430. FIG. 4B is a top view that shows the inner glass pane 430 with the cutaway section 460 at a corner of the pane. The cutaway configuration shown in the examples of FIGS. 4A and 4B can provide fluid communication between airspaces in the IGU assembly 400, such as without using one or more additional components or conduits around an edge portion of the assembly. In an example, more than one corner or other section of the inner glass pane 430 can include a cutaway section, such as to provide a fluid flow path. In an example, one or more through holes can be bored in the inner glass pane 430, such as in addition or alternatively to using the cutaway section 460.

A cutaway at an edge or corner of the inner glass pane 430, such as the cutaway section 460 in the example of FIG. 4, can be inconspicuous and may not appreciably detract from a view through the assembled IGU. A cutaway at a corner can be relatively easy to manufacture because the cut line is contiguous with an edge cut of the ribbon glass stock. One or more through holes can alternatively or additionally be used. Under some circumstances, perforating or cutting one or more holes in a thin inner member can result in uneven stresses applied at or around the holes, and tempering perforated glass can be problematic under some circumstances. Tempering (or other hardening, among other modifications) can more readily be performed on glass with a cutaway at an edge or corner.

In an example, the IGU assembly 400 includes a flowable primary seal at each side of the inner glass pane 430 near the edges of the pane, and between the pane surfaces and respective spacers. In the example of FIG. 4A, primary seals 402 and 404 can be disposed on opposite sides of the inner glass pane 430, and adjacent to the respective first and second spacers 415 and 425.

At the cutaway section 460, the primary seals 402 and 404 on the respective first spacer 415 and second spacer 425 and corresponding generally to opposite sides of the inner glass pane 430, can join or flow together to provide a continuous seal between the first spacer and the second spacer 425 in the cutaway section 460. That is, the primary seals 402 and 404 can meld to become a single primary seal in the region of the cutaway section 460 when the unit is assembled. In an example where the inner glass pane 430 is formed from a glass ribbon having a thickness of about 0.2 mm or less, the primary seal can be sufficient to provide an air-tight, gas-impermeable seal at the region of the cutaway section 460. Thus, no additional seals or components are necessary to provide a sealed gas chamber inside of the IGU assembly 400. As a thickness of the inner glass pane increases, such as in a traditional tri-pane IGU, an additional sealant or sealing member can be required in the region of the cutaway section 460 because of the larger space between the first spacer and the second spacer 425 maintained by the thicker glass. In an example that includes polyisobutylene as the primary sealant material, the polyisobutylene can be applied such that a final thickness of the primary seal between the inner glass pane and an adjacent spacer surface, after assembly, is about 0.5 mm. Thus, in the region of the cutaway section 460, a thickness of the primary seal between the spacer surfaces can be about 1.2 mm total or less. That is, a total thickness of the primary seal in the region of the cutaway section 460 can be greater than the thickness of the inner glass pane 430.

Turning now to FIG. 5, a cross-sectional side view of a portion of a quad-pane IGU 500 is provided. The IGU 500 includes a first outer glass pane 510 and a second outer glass pane 520. The IGU 500 further includes a pair of first and second inner glass panes 531 and 532 that are interposed between the first and second outer glass panes 510 and 520. The first inner glass pane 531 is spaced apart from the first outer glass pane 510 by a first spacer 515 to provide a first airspace 501. The first inner glass pane 531 is spaced apart from the second inner glass pane 532 by a second spacer 525 to provide a second airspace 502. The second inner glass pane 532 is spaced apart from the second outer glass pane 520 by a third spacer 535 to provide a third airspace 503. By providing multiple different airspaces, the quad-pane IGU 500 can provide less heat transfer across the IGU 500 than, for example, is provided using the tri-pane IGU 100. Primary seals, as discussed herein, can be provided on each pane-facing side of the first, second, and third spacers 515, 525, and 535, and a secondary seal 552 can be provided at an outer edge portion of the IGU 500.

An overall thickness of the IGU 500 can be less than a traditional insulating glass unit because the IGU 500 includes a pane formed from a glass ribbon as one or both of the first and second inner glass panes 531 and 532. In an example that includes a pair of glass ribbons as the first and second inner glass panes 531 and 532, the panes can include respective first and second projection portions 541 and 542 that can extend away from the respective spacers adjacent to the pane. That is, at least one of the projection portions 541 and 542 of the first and second inner glass panes 531 and 532 extend past an outer surface of at least one of the first, second, and third spacers 515, 525, and 535. The projection portions 541 and 542 can be received in the secondary seal 552. In an example, the projection portions 541 and 542 extend into the secondary seal 552 and are each recessed from an outer edge or perimeter of the IGU 500, such as by a similar or different distance. Thus, the projection portions 541 and 542 extend into the secondary seal 552 but are each recessed from an outer edge of the first and second outer glass panes 510 and 520.

In an example, the first, second, and third airspaces 501, 502, and 503, of the IGU 500 can include one or more ports configured to provide for fluid (gas) communication between two or more of the airspaces. The one or more ports can include conduit or tubing that fluidly couples each of the airspaces. For example, a first path can be configured for fluid exchange between the first and second airspaces 501 and 502, such as similarly to the example shown in FIG. 3 or FIGS. 4A and 4B. A second path can be configured for fluid exchange between the second and third airspaces 502 and 503, such as similarly to the example shown in FIG. 3 or FIGS. 4A and 4B. In an example, one or more of the first and second inner glass panes 531 and 532 can include a cutaway section. In an example, each of the first and second inner glass panes 531 and 532 includes a cutaway section, such as a nipped corner, to provide fluid communication between adjacent airspaces. In this example, the cutaway sections can be in similar or different locations along an edge of the respective panes, for example, at the same or different corners of the IGU 500.

The inner glass panes discussed in the various examples herein can be formed from a thin, flexible glass sheet or glass ribbon. An example of a thin and flexible glass ribbon includes, but is not limited to, Willow Glass® from Corning Glass.

In an example, glass ribbon can be provided (e.g., shipped to a user or retailer) in a rolled configuration. FIG. 6A illustrates generally a glass ribbon roll 600. A glass ribbon 601 can be wound or coiled about a core 602 of the ribbon roll 600. The glass ribbon 601 can have a thickness and a length. The thickness characteristic can be a nominal or average thickness of the glass ribbon over a length or over a unit area of a portion (e.g., unrolled) of the glass ribbon 601. In an example, the nominal thickness of the glass ribbon 601 is about 0.2 mm or less. In an example, the nominal thickness of the glass ribbon 601 is about 0.1 mm or less.

Systems and methods for producing glass ribbons are described in detail, for example, in Delia et al., U.S. Pat. No. 8,397,538, entitled “Apparatus and method for drawing a ribbon of glass”, which is hereby incorporated herein by reference in its entirety. Delia et al. refers to producing a glass ribbon using a fusion downdraw process. An example of a system 605 for performing a fusion downdraw process is illustrated generally in the example of FIG. 6B.

In a fusion downdraw process, molten glass 620 can be flowed over converging surfaces of a forming body, such as including a forming wedge 610. The molten glass 620 can fuse at a line 622 where the converging surfaces meet to produce a glass ribbon 630. A drawing or stretching apparatus 640 can be provided downstream of the forming wedge 610 to pull or draw the glass ribbon 630 downward. Downstream from the stretching apparatus 640, glass sheets can be cut from the stretched, continuous glass ribbon 630, such as before or after rolling or coiling the ribbon or sheet. Dimensional stability of the glass ribbon 630 can depend upon many factors, including a mass flow distribution of the molten glass 620 over the forming wedge 610, a temperature of the molten glass 620, and a size of the glass ribbon 630, among other factors. In an example, a housing 650 can be provided around the system 605 to augment control of the system 605 temperature.

House et al., in U.S. Patent Application Publication No. 2007/0140311, entitled “Method and apparatus for characterizing a glass ribbon”, which is hereby incorporated herein by reference in its entirety, further discusses systems and methods for forming a glass ribbon. House et al. refers to an apparatus that is configured to form a glass ribbon using pulling rolls that are placed downstream of a forming wedge and in contact with side edges or beads of a glass ribbon, such as without contacting an interior, highly-consistent or “quality” area of the glass ribbon. The pulling rolls can be operated at a set a rate at which the formed ribbon exits the forming wedge, which can also affect a nominal thickness of the final product. In the fusion downdraw glass apparatus described by House et al., as a glass ribbon travels down a drawing portion of the apparatus, the ribbon undergoes structural changes at a molecular level. House et al. explains that the change from a thick, supple liquid at the root of the forming wedge to a stiff glass ribbon of 0.5 mm thickness or less can be achieved by using a carefully selected and maintained temperature field or gradient. The selected temperature field or gradient can be adjusted to balance mechanical and chemical requirements in the conversion of the glass from a liquid, or viscous state, to a solid, or elastic state.

FIG. 7 illustrates generally an example that can include preparing an insulating glass unit using a glass ribbon. At 710, the example can include providing one or more inner glass panes from a portion of a glass ribbon. A glass ribbon can be formed, for example, using the system that is illustrated generally in FIG. 6B. Providing the inner glass pane at 710 can include unrolling a portion of a glass ribbon roll, and cutting a portion of the ribbon to a specified size. Cutting the glass ribbon can include using a laser or other cutting tool.

The glass ribbon provided at 710 can be formed from, among other products, a glass ribbon, such as Willow Glass® by Corning. The glass ribbon can be an ultra-thin, flexible glass sheet or ribbon having a nominal thickness of about 0.2 mm or less, although thicker or thinner glass sock can be used. Glass ribbon can provide several advantages over other, non-glass materials, such as PET or other films. In an IGU assembly, a glass ribbon does not require tensioning, and a glass ribbon will not wrinkle, fade, or discolor over time. In addition, a glass ribbon can be cut or formed in any shape, such as including non-rectangular shapes like triangles, circles, or any shapes that include arcs, acute angles, or obtuse angles. A glass ribbon can be provided having a high or low length-to-width aspect ratio.

In an example, providing the inner glass pane at 710 can further include transporting the cut portion of the glass ribbon to an assembly area. Transporting the glass ribbon can include using a vacuum device configured to pick up the glass ribbon using a specified minimum amount of suction to avoid damaging the glass ribbon.

At 720, the example can include forming a path, such as in one of the inner glass panes provided at 710, or in a frame or other portion of an insulating glass unit or insulating glass window assembly. Forming the path at 720 can include, for example, cutting an edge or corner portion of the inner glass pane that was provided at 710, such as to provide a glass pane with a nipped corner, as described above in the example of FIGS. 4A and 4B.

At 730, the example can include providing respective spacers and seals on opposite sides of an inner glass pane. Providing the respective spacers can include providing discrete spacer units having similar or dissimilar shapes and sizes on opposite sides of the inner glass pane. For example, the respective spacers can have different widths to provide for differently sized gas chamber spaces on opposite sides of the inner glass pane.

At 730, the spacers can be applied to one or both of the inner glass pane and the respective inner glass pane-facing surfaces of the spacers. In an example, only unitary seals are provided between the spacers and the corresponding respective surfaces of the inner glass pane. That is, unlike a film-based insulating unit that requires a method or apparatus to secure or adhere edge portions of a film to corresponding edge portions of the IGU, the inner glass pane, or glass ribbon, can be held between the spacers using only a unitary primary seal at each side of the inner glass pane.

At 740, the example can include providing respective seals and outer glass panes on opposite, outer-facing sides of the respective spacers. The respective seals can be applied to one or both of the exterior-facing surfaces of the spacers and the interior facing surfaces of the outer glass panes. In some examples, an insulating glass unit is constructed by providing a first outer glass pane, and building up the insulating glass unit in layers, beginning at a surface of the first outer glass pane. In other examples, an assembly including the inner glass pane and spacers can be assembled first.

At 750, the example can include providing a secondary seal at the perimeter of the insulating glass unit. The secondary seal can contact, among other portions of the unit, inner surfaces of the outer glass panes, exterior-facing surfaces of the spacers, and exterior-facing portions of the primary seals. The secondary seal can optionally receive an edge portion of the inner glass pane. In an example, the edge portion of the inner glass pane extends into, but not all the way through, the secondary seal.

### Examples and Notes

Example 1 can include or use subject matter (such as an apparatus or a method), such as can include or use an insulating glass unit comprising a pair of outer glass panes that are spaced apart, and at least one inner glass pane, positioned between the pair of outer glass panes, the inner glass pane spaced apart from each of the outer glass panes to provide first and second gas chambers on opposite sides of the inner glass pane. Example 1 can optionally include wherein the first and second gas chambers are in fluid communication, or wherein the at least one inner glass pane is a flexible glass ribbon that has a nominal thickness that is less than a nominal thickness of either one of the outer glass panes.

Example 2 can include, or can optionally be combined with the subject matter of Example 1, to optionally include wherein the inner glass pane includes a portion of a coilable, flexible glass ribbon.

Example 3 can include, or can optionally be combined with the subject matter of one or any combination of Examples 1 or 2 to optionally include wherein the at least one inner glass pane has a nominal thickness that is about 0.2 mm or less.

Example 4 can include, or can optionally be combined with the subject matter of one or any combination of Examples 1 through 3 to optionally include wherein the at least one inner glass pane has a nominal thickness that is about 0.1 mm or less.

Example 5 can include, or can optionally be combined with the subject matter of one or any combination of Examples 1 through 4 to optionally include first and second spacers, the first spacer positioned between the inner glass pane and a first one of the outer glass panes, and the second spacer positioned between the inner glass pane and a second one of the outer glass panes.

Example 6 can include, or can optionally be combined with the subject matter of Example 5, to optionally include primary gas-impermeable seals positioned on opposite sides of the inner glass pane between respective surfaces of the inner glass pane and corresponding surfaces of the spacers.

Example 7 can include, or can optionally be combined with the subject matter of Example 6, to optionally include the primary gas-impermeable seals further comprise seals positioned between respective spacer-facing surfaces of the outer glass panes and corresponding surfaces of the spacers.

Example 8 can include, or can optionally be combined with the subject matter of one or any combination of Examples 6 or 7 to optionally include the primary gas-impermeable seals include polyisobutylene.

Example 9 can include, or can optionally be combined with the subject matter of one or any combination of Examples 6 through 8 to optionally include a secondary seal disposed between the outer glass panes and along an edge of the insulating glass unit, wherein the secondary seal receives and encapsulates an edge portion of the inner glass pane, and wherein the secondary seal comprises, for example, a flexible polymer having a cohesive strength that exceeds a cohesive strength of the primary seals.

Example 10 can include, or can optionally be combined with the subject matter of one or any combination of Examples 5 through 9 to optionally include on each side of the inner glass pane and at respective inner glass pane-facing surfaces of the first and second spacers, only a single unitary seal positioned between respective surfaces of the inner glass pane and the corresponding inner glass pane-facing surfaces of the first and second spacers, the single unitary seal comprising a viscous, gas-impermeable material.

Example 11 can include, or can optionally be combined with the subject matter of one or any combination of Examples 1 through 10 to optionally include a perimeter length of the inner glass pane is less than a perimeter length of at least one of the outer glass panes.

Example 12 can include, or can optionally be combined with the subject matter of one or any combination of Examples 1 through 11 to optionally include an edge of the inner glass pane is recessed relative to a corresponding edge of at least one of the outer glass panes.

Example 13 can include, or can optionally be combined with the subject matter of one or any combination of Examples 1 through 12 to optionally include the perimeter of the inner glass pane and of the outer glass panes is non-rectangular. For example, the perimeter of the inner glass pane can be circular, oval, arc-shaped, or otherwise shaped.

Example 14 can include, or can optionally be combined with the subject matter of one or any combination of Examples 1 through 13 to optionally include the first and second gas chambers are in fluid communication using a fluid path or port through the inner glass pane.

Example 15 can include, or can optionally be combined with the subject matter of Example 14, to optionally include wherein the fluid path or port includes at least one differently shaped corner portion of the inner glass pane having a different shape than two or more other corner portions of the inner glass pane, the at least one differently shaped corner portion providing a passage for fluid exchange between the first and second gas chambers.

Example 16 can include, or can optionally be combined with the subject matter of one or any combination of Examples 1 through 15 to optionally include wherein the first and second gas chambers are in fluid communication using a fluid path or port that extends around an outer edge of the inner glass pane.

Example 17 can include or use subject matter (such as an apparatus or a method), such as can include or use an insulating glass unit comprising a pair of outer glass panes that are spaced apart, the pair of outer glass panes having substantially the same perimeter length and planar profile, and at least one inner glass pane, positioned between the pair of outer glass panes, the inner glass pane spaced apart from each of the outer glass panes to provide first and second gas chambers on opposite sides of the inner glass pane. In Example 17, the inner glass pane includes two or more side edges that are recessed relative to corresponding edges of the outer glass panes, is an uncoiled glass ribbon, and has a nominal thickness that is less than a nominal thickness of either one of the outer glass panes by at least an order of magnitude. In Example 17, the first and second gas chambers are in fluid communication using a fluid path or port at a corner of the inner glass pane.

Example 18 can include, or can optionally be combined with the subject matter of Example 17, to optionally include first and second spacers, the first spacer positioned between the inner glass pane and a first one of the outer glass panes, and the second spacer positioned between the inner glass pane and a second one of the outer glass panes, each of the first and second spacers having a thickness that is greater than the thickness of the inner glass pane.

Example 19 can include, or can optionally be combined with the subject matter of Example 18, to optionally include wherein at least one of the first and second spacers has a thickness that is greater than the thickness of at least one of the outer glass panes.

Example 20 can include, or can optionally be combined with the subject matter of one or any combination of Examples 17 through 19 to optionally include a gas-impermeable seal positioned between a surface of at least one of the spacers and a corresponding surface of the inner glass pane.

Example 21 can include, or can optionally be combined with the subject matter of Example 20, to optionally include wherein the gas-impermeable seal includes polyisobutylene.

Example 22 can include, or can optionally be combined with the subject matter of one or any combination of Examples 17 through 21 to optionally include an edge seal disposed between the outer glass panes and adjacent to the perimeter edges of the outer glass panes, the edge seal contacting a perimeter edge of the inner glass pane.

Example 23 can include, or can optionally be combined with the subject matter of Example 22, to optionally include wherein an edge portion of the inner glass pane is received in the edge seal, and the depth of the received edge portion in the edge seal exceeds a thickness of the inner glass pane.

Example 24 can include, or can optionally be combined with the subject matter of one or any combination of Examples 17 through 23 to optionally include the planar profile of the inner glass pane and the planar profile of the outer glass panes is non-rectangular.

Example 25 can include or use subject matter (such as an apparatus or a method), such as can include or use a method for making an insulating glass unit, the method comprising providing an inner glass pane from an unrolled portion of a flexible glass ribbon, providing a pair of outer glass panes, the outer glass panes each having a thickness that is greater than the inner glass pane, forming a path in at least one of the inner glass pane or a frame of the insulating glass unit, and assembling the insulating glass unit with the inner glass pane interposed between the pair of outer glass panes, including positioning a first spacer near a perimeter edge of the insulating glass unit between a first one of the outer glass panes and a first side of the inner glass pane, and positioning a second spacer near a perimeter edge of the insulating glass unit between a second one of the outer glass panes and a second side of the inner glass pane. Such a method for making an insulating glass unit can be performed in a vertical, horizontal, or other orientation.

Example 26 can include, or can optionally be combined with the subject matter of Example 25, to optionally include wherein the forming the inner glass pane includes forming the inner glass pane having a first perimeter length, and wherein the forming the pair of outer glass panes includes forming the outer glass panes having respective second and third perimeter lengths that are greater than the first perimeter length of the inner glass pane.

Example 27 can include, or can optionally be combined with the subject matter of one or any combination of Examples 25 or 26 to optionally include wherein the assembling the insulating glass unit includes providing a viscous, gas-impermeable seal between the inner glass pane and the spacers.

Example 28 can include, or can optionally be combined with the subject matter of Example 27, to optionally include wherein the providing the viscous, gas-impermeable seal includes providing polyisobutylene on each side of the inner glass pane and having a nominal thickness on each side of the inner glass pane that is greater than the nominal thickness of the inner glass pane.

Example 29 can include, or can optionally be combined with the subject matter of one or any combination of Examples 25 through 28 to optionally include the forming the inner glass pane includes unrolling a portion of a glass ribbon roll, cutting an inner glass pane edge from the unrolled portion of the glass ribbon roll, the cutting including using a laser, and optionally transporting the cut inner glass pane, such as using a vacuum transport device.

Example 30 can include, or can optionally be combined with the subject matter of one or any combination of Examples 25 through 30 to optionally include providing a secondary seal about the perimeter edge of the insulating glass unit, including receiving an end edge portion of the inner glass pane in the secondary seal, the end edge portion of the inner glass pane extending outward from an outer perimeter edge of the spacers.

These non-limiting examples can be combined in any permutation or combination.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. An insulating glass unit comprising:
a pair of outer glass panes that are spaced apart; and
at least one inner glass pane, positioned between the pair of outer glass panes, the inner glass pane spaced apart from each of the outer glass panes to provide first and second gas chambers on opposite sides of the inner glass pane;
wherein the first and second gas chambers are in fluid communication; and
wherein the at least one inner glass pane is a flexible glass ribbon that has a nominal thickness that is less than a nominal thickness of either one of the outer glass panes.

2. The insulating glass unit of claim 1, wherein the inner glass pane includes a portion of a coilable, flexible glass ribbon.

3. The insulating glass unit of claim 1, wherein the at least one inner glass pane has a nominal thickness that is about 0.2 mm or less.

4. The insulating glass unit of claim 1, wherein the at least one inner glass pane has a nominal thickness that is about 0.1 mm or less.

5. The insulating glass unit of claim 1, comprising first and second spacers, the first spacer positioned between the inner glass pane and a first one of the outer glass panes, and the second spacer positioned between the inner glass pane and a second one of the outer glass panes.

6. The insulating glass unit of claim 5, comprising primary gas-impermeable seals positioned on opposite sides of the inner glass pane between respective surfaces of the inner glass pane and corresponding surfaces of the spacers.

7. The insulating glass unit of claim 6, wherein the primary gas-impermeable seals further comprise seals positioned between respective spacer-facing surfaces of the outer glass panes and corresponding surfaces of the spacers.

8. The insulating glass unit of claim 6, wherein the primary gas-impermeable seals include polyisobutylene.

9. The insulating glass unit of claim 6, comprising a secondary seal disposed between the outer glass panes and along an edge of the insulating glass unit, wherein the secondary seal receives and encapsulates an edge portion of the inner glass pane, and wherein the secondary seal comprises a flexible polymer having a cohesive strength that exceeds a cohesive strength of the primary seals.

10. The insulating glass unit of claim 5, comprising, on each side of the inner glass pane at the first and second spacers, only a single unitary seal positioned between respective surfaces of the inner glass pane and corresponding surfaces of the first and second spacers, the single unitary seal comprising a viscous, gas-impermeable material.

11. The insulating glass unit of claim 1, wherein a perimeter length of the inner glass pane is less than a perimeter length of at least one of the outer glass panes.

12. The insulating glass unit of claim 1, wherein an edge of the inner glass pane is recessed relative to a corresponding edge of at least one of the outer glass panes.

13. The insulating glass unit of claim 1, wherein the perimeter of the inner glass pane and of the outer glass panes is non-rectangular.

14. The insulating glass unit of claim 1, wherein the first and second gas chambers are in fluid communication using a path through the inner glass pane.

15. The insulating glass unit of claim 14, wherein the path includes at least one differently shaped corner portion having a different shape than two or more other corner portions of the inner glass pane, the at least one differently shaped corner portion providing a passage for fluid exchange between the first and second gas chambers.

16. The insulating glass unit of claim 1, wherein the first and second gas chambers are in fluid communication using a path that extends around an outer edge of the inner glass pane.

17. An insulating glass unit comprising:
a pair of outer glass panes that are spaced apart, the pair of outer glass panes having substantially the same perimeter length and planar profile; and
at least one inner glass pane, positioned between the pair of outer glass panes, the inner glass pane spaced apart from each of the outer glass panes to provide first and second gas chambers on opposite sides of the inner glass pane, and the inner glass pane:
includes two or more side edges that are recessed relative to corresponding edges of the outer glass panes;
is an uncoiled glass ribbon; and
has a nominal thickness that is less than a nominal thickness of either one of the outer glass panes by at least an order of magnitude;
wherein the first and second gas chambers are in communication using a fluid path at a corner of the inner glass pane.

18. The insulating glass unit of claim 17, comprising first and second spacers, the first spacer positioned between the inner glass pane and a first one of the outer glass panes, and the second spacer positioned between the inner glass pane and a second one of the outer glass panes, each of the first and second spacers having a thickness that is greater than the thickness of the inner glass pane.

19. The insulating glass unit of claim 18, wherein at least one of the first and second spacers has a thickness that is greater than the thickness of at least one of the outer glass panes.

20. The insulating glass unit of claim 17, comprising a gas-impermeable seal positioned between a surface of at least one of the spacers and a corresponding surface of the inner glass pane.

21. The insulating glass unit of claim 20, wherein the gas-impermeable seal includes polyisobutylene.

22. The insulating glass unit of claim 17, comprising an edge seal disposed between the outer glass panes and adjacent to the perimeter edges of the outer glass panes, the edge seal contacting a perimeter edge of the inner glass pane.

23. The insulating glass unit of claim 22, wherein an edge portion of the inner glass pane is received in the edge seal, and the depth of the received edge portion in the edge seal exceeds a thickness of the inner glass pane.

24. The insulating glass unit of claim 17, wherein the planar profile of the inner glass pane and the planar profile of the outer glass panes is non-rectangular.

25. A method for making an insulating glass unit, the method comprising:
providing an inner glass pane from an unrolled portion of a flexible glass ribbon;
providing a pair of outer glass panes, the outer glass panes each having a thickness that is greater than the inner glass pane;
forming a path in at least one of the inner glass pane or a frame of the insulating glass unit; and
assembling the insulating glass unit with the inner glass pane interposed between the pair of outer glass panes, including positioning a first spacer near a perimeter edge of the insulating glass unit between a first one of the outer glass panes and a first side of the inner glass pane, and positioning a second spacer near a perimeter edge of the insulating glass unit between a second one of the outer glass panes and a second side of the inner glass pane.

26. The method of claim 25, wherein the forming the inner glass pane includes forming the inner glass pane having a first perimeter length, and wherein the forming the pair of outer glass panes includes forming the outer glass panes having respective second and third perimeter lengths that are greater than the first perimeter length of the inner glass pane.

27. The method of claim 25, wherein the assembling the insulating glass unit includes providing a viscous, gas-impermeable seal between the inner glass pane and the spacers.

28. The method of claim 27, wherein the providing the viscous, gas-impermeable seal includes providing polyisobutylene on each side of the inner glass pane and having a nominal thickness on each side of the inner glass pane that is greater than the nominal thickness of the inner glass pane.

29. The method of claim 25, wherein the forming the inner glass pane includes:
unrolling a portion of a glass ribbon roll;
cutting an inner glass pane edge from the unrolled portion of the glass ribbon roll, the cutting including using a laser; and
transporting the cut inner glass pane using a vacuum transport device.

30. The method of claim 25, comprising providing a secondary seal about the perimeter edge of the insulating glass unit, including receiving an end edge portion of the inner glass pane in the secondary seal, the end edge portion of the inner glass pane extending outward from an outer perimeter edge of the spacers.
